(19) United States
(12) Patent Application Publication
(10) Pub. No.: US 2021/0385136 A1
(43) Pub. Date: Dec. 9, 2021

(54) PERSONAL DIGITAL OPERATION ASSISTANT

(71) Applicant: SAP SE, Walldorf (DE)

(72) Inventors: Frank Misch, Heidelberg (DE); Christian Martick, Wendisch Rietz (DE); Volker Driesen, Heidelberg (DE)

(21) Appl. No.: 16/896,407

(22) Filed: Jun. 9, 2020

(51) Int. Cl. H04L 12/24; G06F 3/16; G10L 15/22; G10L 13/04; G10L 15/18

(52) U.S. Cl. CPC H04L 41/20; G06F 3/167; G10L 2015/223; G10L 13/043; G10L 15/18; G10L 15/22

(57) ABSTRACT

Methods, systems, and computer-readable storage media for receiving, by a personal digital operation assistant (Pedoa) system, user input, processing, by the Pedoa system, the user input to determine an intent and one or more entities related to at least a portion of a landscape, transmitting, by a dispatcher of the Pedoa system, a request to one or more services of the Pedoa system based on the intent and the one or more entities, receiving, by the dispatcher, one or more responses from the one or more services of the Pedoa system, each response being responsive to the request, and providing, by the Pedoa system, output data to a user through one or more user interfaces (UIs), the output data representative of activity of one or more components within the landscape.

### BACKGROUND

Enterprises can use software systems to support and execute operations. In many cases, enterprises can use hundreds to thousands of software systems across a landscape. In many cases, enterprises can use hundreds to thousands of software systems and/or services underlying the software systems (e.g., in a micro-services architecture) across a landscape. Execution of software systems across a landscape implies management of the landscape components across the landscape.

Landscape management systems enable administrators to manage execution of the processes for operating system landscapes. Operation and management of a landscape has become increasingly complex from a technical perspective and can consume significant resources. In such landscapes, many components are operated and typically, the components have respective operation tools that are used as part of landscape management. Consequently, an operator can be confronted with a relatively large set of tools that are heterogeneous. In some examples, the different tools have respective user interfaces (UIs) and write respective logs.

Further, tools provide respective monitoring functionality to monitor execution processes. For example, for running processes, active monitoring is required (e.g., to determine whether the process is still running, within expected time frame, within planned downtime windows, etc.). If several processes run in parallel, active monitoring of resources can be key to avoiding resource shortages, which can lead to process failure. This requires the operator to handle several, different notification mechanisms in case of process failures. In some instances, analysis of a process spanning several tools can be required, in which numerous logs have to be analyzed and information of different monitoring databases can be consulted.

There is an increased demand on availability of landscape components (i.e., minimization of downtime), which requires landscapes to be managed with fewer and fewer errors. For example, if an action (e.g., a task within a process) is planned by an administrator (e.g., stopping a service), it may be unknown as to what the impact of the action will be. If an action is running, it is not known whether the action is within expected runtimes, which can contribute to in unexpected and/or prolonged downtime. Further, to support efficient management of landscapes, active analysis of planned and executed process and their statistics are required. For example, if an administrator wants to know which actions are planned for a particular period of time (e.g., day, night, weekend, next hour, etc.), this information can be provided from respective scheduling systems. Typically, the administrator wants to know, which actions are erroneous or exceptional and need to be followed-up on.

### SUMMARY

Implementations of the present disclosure are directed to landscape management of information technology (IT) systems. More particularly, implementations of the present disclosure are directed to a personal digital operation assistant system for users of a landscape management system.

In some implementations, actions include receiving, by a personal digital operation assistant (Pedoa) system, user input, processing, by the Pedoa system, the user input to determine an intent and one or more entities related to at least a portion of a landscape, transmitting, by a dispatcher of the Pedoa system, a request to one or more services of the Pedoa system based on the intent and the one or more entities, receiving, by the dispatcher, one or more responses from the one or more services of the Pedoa system, each response being responsive to the request, and providing, by the Pedoa system, output data to a user through one or more user interfaces (UIs), the output data representative of activity of one or more components within the landscape. Other implementations of this aspect include corresponding systems, apparatus, and computer programs, configured to perform the actions of the methods, encoded on computer storage devices.

These and other implementations can each optionally include one or more of the following features: the one or more services of the Pedoa system include a schedule information service, a landscape information service, a tool information service, and a monitoring service; the output data is provided at least partially based on a customization configuration that defines one or more components of the landscape relevant to the user; the output data includes statistics data representative of execution of a process within the landscape; the output data is audio data generated by a natural language processing (NLP) system at least partially based on the one or more responses; the one or more UIs include a graphical UI and a conversation UI (CUI), the CUI enabling speech-based communication between the Pedoa system and the user; and the Pedoa system is integrated within a landscape management system that is used to manage the landscape.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIG. 2 depicts an example conceptual architecture for a personal digital operation assistant (Pedoa) system for users of a landscape management system in accordance with implementations of the present disclosure.

FIG. 3 depicts an example processes that can be executed in accordance with implementations of the present disclosure.

FIG. 4 is a schematic illustration of example computer systems that can be used to execute implementations of the present disclosure.

Like reference symbols in the various drawings indicate like elements.

### DETAILED DESCRIPTION

Implementations of the present disclosure are directed to landscape management of information technology (IT) systems. More particularly, implementations of the present disclosure are directed to a personal digital operation assistant system for users of a landscape management system. Implementations can include actions of receiving, by a personal digital operation assistant (Pedoa) system, user input, processing, by the Pedoa system, the user input to determine an intent and one or more entities related to at least a portion of a landscape, transmitting, by a dispatcher of the Pedoa system, a request to one or more services of the Pedoa system based on the intent and the one or more entities, receiving, by the dispatcher, one or more responses from the one or more services of the Pedoa system, each response being responsive to the request, and providing, by the Pedoa system, output data to a user through one or more user interfaces (UIs), the output data representative of activity of one or more components within the landscape.

Implementations of the present disclosure are described in further detail herein with reference to an example landscape management system. An example landscape management system includes SAP Landscape Management (LaMa) provided by SAP SE of Walldorf, Germany. It is contemplated, however, that implementations of the present disclosure can be realized with any appropriate landscape management system.

To provide further context for implementations of the present disclosure, enterprises can use software systems to support and execute operations. Example software systems can include, without limitation, enterprise resource planning (ERP) systems, customer relationship management (CRM) systems, data warehouse systems, and the like. In many cases, enterprises can use hundreds to thousands of software systems and/or services underlying the software systems (e.g., in a micro-services architecture) across a landscape. A landscape can include components (which can also be referred to as IT components), such as the software systems, services, servers, computing devices, and the like. In many instances, landscapes can be relatively large including, for example, thousands of landscape components. Landscapes can be provisioned in on-premise environments and/or cloud-computing environments.

Execution of software systems across a landscape implies management of the landscape components across the landscape. For example, numerous IT processes (also referred to as processes herein) can be executed across the landscape during management of the landscape to maintain appropriate operation of the software systems. For relatively large landscapes, this can include hundreds to thousands of processes. To handle this, landscape management systems have been developed that enable execution and monitoring of processes. In some examples, landscape management systems enable manual execution, semi-automated execution, and/or fully-automated execution of processes.

Landscape management systems enable administrators to manage execution of the processes for operating system landscapes. An administrator can include, without limitation, an administrator of an enterprise running on-premise software, an administrator of cloud landscape running several services, or a development operations (dev-ops) team responsible for one or more services. Example processes managed by an administrator can include, without limitation, provisioning of a new system or tenant, upgrade of components deployed in the landscape, adding a service to the landscape, restarting a service start/stop of systems, relocation of systems (or instances) from one host to another host, efficient mass operations on a complete landscape or parts of a landscape, constant validation of landscapes, system copy/cloning/provisioning, automated capacity management, operations on chains of dependent systems, and additional reporting, monitoring and visualization capabilities. To implement these operations, landscape management systems leverage and integrate with infrastructure components and services. These can include, for example, platform and storage virtualization, network management, and central user management. Landscape management systems can leverage tools, components, and services for the automation of specific tasks (e.g., installation of application servers, renaming of a system, start/stop of servers).

Modern landscapes include micro-service architectures and processes that can span several systems, tenants and services. Consequently, operation and management of a landscape has become increasingly complex from a technical perspective and can consume significant resources. In such landscapes, many components are operated and typically, the components have respective operation tools that are used as part of landscape management. Consequently, an operator can be confronted with a relatively large set of tools that are heterogeneous. In some examples, the different tools have respective user interfaces (UIs) and write respective logs.

Further, tools provide respective monitoring functionality to monitor execution processes. For example, for running processes, active monitoring is required (e.g., to determine whether the process is still running, within expected time frame, within planned downtime windows, etc.). If several processes run in parallel, active monitoring of resources can be key to avoiding resource shortages, which can lead to process failure. This requires the operator to handle several, different notification mechanisms in case of process failures. In some instances, analysis of a process spanning several tools can be required, in which numerous logs have to be analyzed and information of different monitoring databases can be consulted.

There is an increased demand on availability of landscape components (i.e., minimization of downtime), which requires landscapes to be managed with fewer and fewer errors. For example, if an action (e.g., a task within a process) is planned by an administrator (e.g., stopping a service), it may be unknown as to what the impact of the action will be. If an action is running, it is not known whether the action is within expected runtimes, which can contribute to in unexpected and/or prolonged downtime.

Further, to support efficient management of landscapes, active analysis of planned and executed process and their statistics are required. For example, if an administrator wants to know which actions are planned for a particular period of time (e.g., day, night, weekend, next hour, etc.), this information can be provided from respective scheduling systems. For example, in the evening or on Monday, if an administrator wants to get an overview of the activities of the day or weekend before, data needs to be retrieved from log systems. Typically, the administrator wants to know, which actions are erroneous or exceptional and need to be followed-up on.

In view of this, and as described in further detail herein, implementations of the present disclosure provide a personal digital operation assistant (Pedoa) system for users of a landscape management system. In some implementations, a user (e.g., an administrator of a landscape) interacts with the Pedoa system through one or more user interfaces (UIs). Example UIs can include, without limitation, a graphical UI (GUI) and a conversational UI (CUI). In some examples, the CUI can be implemented using a natural language interface (NLI) using natural language processing (NLP). In accordance with implementations of the present disclosure, tools executing processes in the landscape report ongoing progress, errors, alerts, and/or statistics (collectively referred to as component data) to the Pedoa.

In some implementations, the Pedoa system stores the component data in a persistency and provides data retrieval services and analytical capabilities on the component data. In some examples, the Pedoa system provides event filtering and can forward tool progress information to the user based on one or more configurations provided by the user. In some examples, the Pedoa system can use process schedules and component data of executed processes and to generate a pre-execution briefing and/or a post-execution de-briefing to the user through the UIs. In some implementations, and as described in further detail herein, the Pedoa system is non-invasive in supporting the user, and is responsive to direction of the user, as opposed to acting autonomously and providing unprompted output to the user.

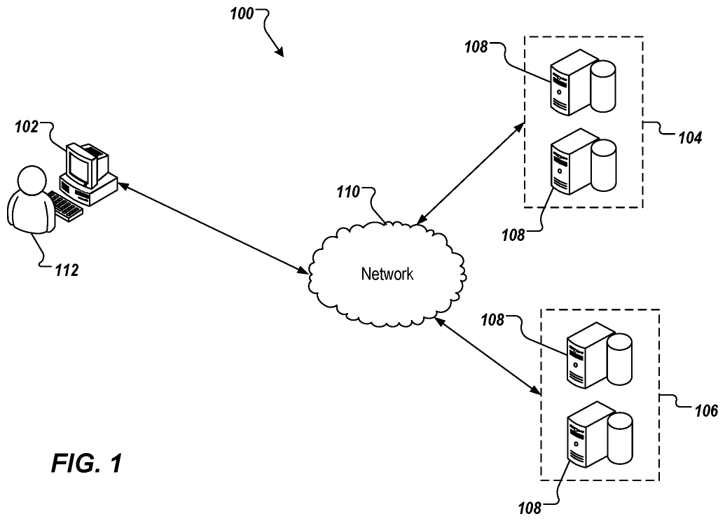

FIG. 1 depicts an example architecture 100 in accordance with implementations of the present disclosure. In the depicted example, the example architecture 100 includes a client device 102, a network 110, and server systems 104, 106. The server systems 104, 106 each include one or more server devices and databases 108 (e.g., processors, memory). In the depicted example, a user 112 interacts with the client device 102.

In some examples, the client device 102 can communicate with the server system 104 and/or the server system 106 over the network 110. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 110 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, each of the server systems 104, 106 includes at least one server and at least one data store. In the example of FIG. 1, the server systems 104, 106 are intended to represent various forms of servers including, but not limited to a web server, an application server, a proxy server, a network server, and/or a server pool. In general, server systems accept requests for application services and provides such services to any number of client devices (e.g., the client device 102 over the network 106).

In accordance with implementations of the present disclosure, and as noted above, the server system 104 can host one or more managed systems (landscapes) that support operations of one or more enterprises. Further, the server system 106 can host a landscape management system that is used to execute IT operations on landscape components of the managed systems of the server system 104. In some implementations, the server system 106 hosts the Pedoa system for landscape management of the present disclosure. For example, the Pedoa system can be integrated within the landscape management system executing in the server system 106. As another example, the Pedoa system can be hosted independent of, but interact with the landscape management system within the sever system 106.

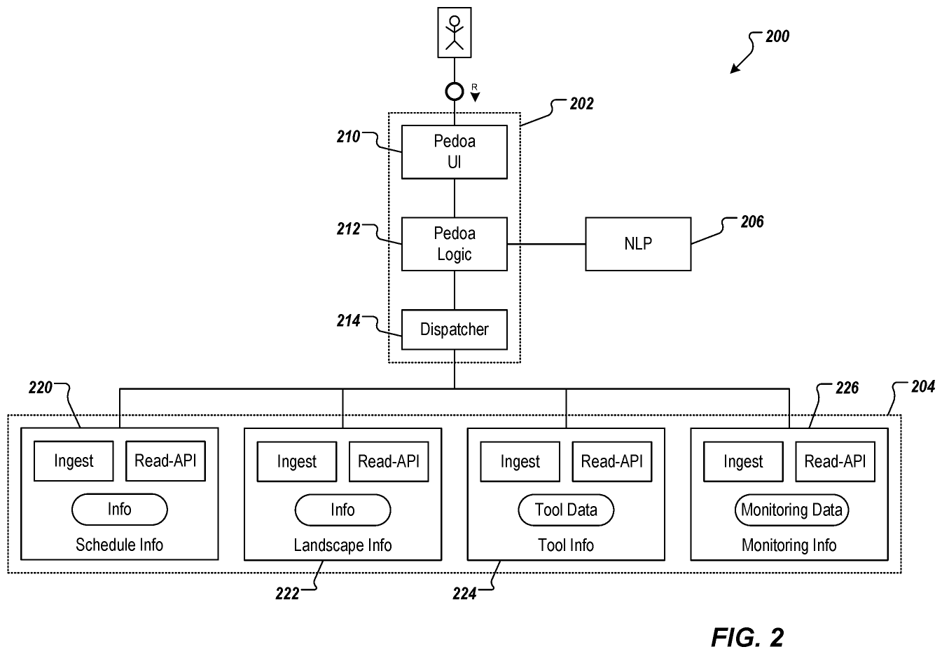

FIG. 2 depicts an example conceptual architecture 200 for a Pedoa system for users of a landscape management system in accordance with implementations of the present disclosure. The example conceptual architecture 200 includes a personal digital operation assistant (Pedoa) 202, a set of services 204, and a natural language processing (NLP) system 206. In some examples, the NLP system 206 can be a third-party system that is leveraged by the Pedoa system 202 (e.g., the Pedoa system 202 transmits NLP requests to and receives responses from the NLP system 206 through an application programming interface (API)). In some examples, the NLP system 206 can be a part of (integrated within) the Pedoa system 202. In some examples, the Pedoa 202 and the set of services 204 can be collectively referred to as a Pedoa system. In some examples, the Pedoa 202, the set of services 204, and the NLP system 206 can be collectively referred to as a Pedoa system.

In the example of FIG. 2, the Pedoa 202 includes a Pedoa user interface (UI) 210, Pedoa logic 212, and a dispatcher 214. In some examples, the Pedoa UI can be provided as a GUI and/or a CUI. In some examples, the Pedoa logic 212 provides functionality for receiving input from and conveying component data to the Pedoa UI 210. For example, the Pedoa logic 212 receive user input from the Pedoa UI, which is provided by a user (e.g., administrator). In some examples, communication between the user and the Pedoa system can be achieved using a dedicated Pedoa syntax and/or GUI/command-line interface.

In some examples, the user input explicitly indicates an intent and one or more entities. For example, the user input can be provided through user selection of interface elements displayed in a GUI, the user interface elements corresponding to an intent and the one or more entities selected by the user. Example intents can include, without limitation, [status, statistics, schedule, execute, information]. Example entities can include, without limitation, [process, component, tool, time/date]. For example, the user input can indicate [status, Process_ID], which represents a request for the status of the process corresponding to Process_ID (e.g., Process_ID uniquely identifies the process among multiple processes). As another example, the user input can indicate [schedule, Process_ID=1234XA, 30/6/2020-0800], which represents a request for the process corresponding to Process_ID to be scheduled for execution at a specified time/date (e.g., Jun. 30, 2020 at 8:00 AM).

In some examples, the Pedoa logic 212 can selectively access the NLP system 206 to discern the user input. For example, the user input can include speech input provided received by the Pedoa logic 212 as an audio file. In some examples, intents and/or entities are not readily discernible by the Pedoa logic 212 from audio data recorded in the audio file. In response to the speech input (e.g., in response to receiving an audio file from the Pedoa UI), the Pedoa logic 212 can issue a request to the NLP system 206, which can process the audio file (e.g., using speech-to-text recognition) to provide text data.

In some examples, the NLP system 206 can process the text data to determine an intent and one or more entities representative of a user request. For example, tokens (e.g., strings of text) in the text data can be compared to a set of intents, and, if a token matches an intent in the set of intents, the token is provided as an intent in the user input. Continuing with the example above, if a token is provided as [status], it can be determined that [status] is included in the set of intents, and [status] can be included in the user input as an intent. As another example, a pattern of each token can be compared to a set of entity patterns, each entity pattern corresponding to an entity. If the pattern of a token matches an entity pattern in the set of entity patterns, the token can be provided as an entity in the user input. Continuing with the example above, if a token is provided as [1234XA], it can be determined that [1234XA] has an entity pattern [####__] (e.g., where #indicates number and _indicates letter), which is included in the set of entity patterns as a process identifier pattern, and [1234XA] can be included in the user input as an intent. In the above example, the user input can be returned as [status, Process_ID=1234XA].

In some implementations, the Pedoa logic 212 can provide output data that is to be presented to the user by the Pedoa UI 210. For example, and as described in further detail herein, the Pedoa logic 212 can receive component data from the dispatcher 214 and can provide output data to the Pedoa UI 210. In some examples, the output data is provided as the component data (or at least a portion of the component data) received from the dispatcher 214 and can be displayed in a GUI by the Pedoa UI 210. In some examples, it can be determined that the output data is to be provided as audio data (e.g., if the user is using a CUI of the Pedoa system), and, in response, a request can be sent to the NLP system 206 to provide the output data. In some examples, the NLP system 206 processes the output data (e.g., using text-to-speech) to provide audio data in an audio file that is returned to the Pedoa logic 212 as the output data. The Pedoa logic 212 transmits the output data to the Pedoa UI 210, which processes the output data to provide sound to the user (e.g., “Hello User, the status of process 1234XA is complete without error.”).

In some implementations, the dispatcher 214 routes requests to services of the set of services 204 and provides responses to the Pedoa logic 212 received from services of the set of services 204. In some examples, and as described herein, the responses include component data. In the example of FIG. 2, services in the set of services 204 include a schedule information service 220, a landscape information service 222, a tool information service 224, and a monitoring service 226. It is contemplated, however, that the set of services 204 can include any appropriate service. In some examples, the dispatcher 214 routes a request based on the intent and entity provided in user input received from the Pedoa logic 212. For example, if the user input indicates a request for the status of a process, the dispatcher can route a request to the monitoring service 226, the request indicating the Process_ID of the process. As another example, if the user input indicates a request for statistics associated with an execution of a process, the dispatcher can route a request to the tool information service 224, the request indicating the Process_ID of the process.

To this end, and in some example, the dispatcher 214 can maintain a table of services, each service in the table of services indexed to one or more intents. In this manner, for an intent received in the user input, the dispatcher 214 can identify one or more services from the table and can dispatch a request to each of the one or more services. In some examples, each service can be associated with a respective request template, which defines a format for the request and information to be included in the request. Each request dispatched by the dispatcher 214 is provided in the format and includes the information.

In some implementations, the schedule information service 220 receives and stores schedule information related to components of a landscape. In some examples, the schedule information service 220 can request and store information associated with scheduled tasks from the landscape (not shown in FIG. 2). In some examples, the information is associated with a defined period in time (e.g., day, week, month, year). In some examples, the information is limited to activities described by one or more attributes (e.g., service type, data center, line-of-business, etc.). In some examples, the information includes planning data, which can describe, which process is planned for execution within which component of the landscape and can also include time/date scheduled and dependencies. The information and planning data ingested by the schedule information service 220 is stored in a persistency, which is selectively accessed in response to a request from the dispatcher 214.

In some implementations, the landscape information service 222 receives and stores landscape information that describes components within the landscape and dependencies therebetween. In some examples, the landscape information service 222 ingests landscape information by accessing (reading) a landscape directory provided within the landscape. Example landscape information can include, without limitation, component identifiers that uniquely identify components within the landscape, and dependencies between components. The landscape information ingested by the landscape information service 222 is stored in a persistency, which is selectively accessed in response to a request from the dispatcher 214.

In some implementations, the tool information service 224 receives and stores tool data provided from one or more tools that are used to manage the landscape. In some examples, the tool information service 224 ingests tool data for components of a landscape. For example, the tool information service 224 can query tools based on component identifiers and the tools can return tool information responsive to queries. Example tool information can include, without limitation, statistics data and component data. Example statistics can include, without limitation, average (e.g., average execution time of a process), standard deviation, list of events deviating from average by more than standard deviation, and the like. Example component data can include, without limitation, progress information and error messages. The tool information ingested by the tool information service 224 is stored in a persistency, which is selectively accessed in response to a request from the dispatcher 214.

In some implementations, the monitoring information service 226 receives and stores monitoring data provided from monitoring of the landscape. In some examples, monitoring data can represent running systems and services within the landscape. The monitoring data ingested by the monitoring information service 226 is stored in a persistency, which is selectively accessed in response to a request from the dispatcher 214.

In some implementations, the Pedoa system is integrated into the working environment of the user (e.g., administrator, dev-ops team member). For example, and as discussed above with reference to FIG. 1, the Pedoa system can be integrated within the landscape management system (e.g., SAP LaMa) executing in the server system 106. For example, the Pedoa UI 210 can be provided as a side-window within a landscape management UI of the landscape management system (e.g., in a so-called co-pilot configuration).

In some implementations, the Pedoa system can be customized by a user. In some examples, a customization configuration can be provided and can be defined by the user, the customization configuration identifying a set of components (and/or systems as a group of components) and a time period (e.g., per component, or for the set of components). In some examples, the Pedoa logic 212 can selectively filter output data based on the customization configuration. For example, if the output data includes data that is not representative of a component indicating in the customization configuration and/or is not within a respective time period, the output data is not provided to the Pedoa UI 210.

As one example, an administrator can be tasked with managing a set of systems and/or a set of components within the landscape over a defined period of time. Consequently, the user can customize the Pedoa system using a customization configuration, such that component data for the set of systems and/or the set of components is only provided to the user over the period of time. In this manner, the Pedoa system does not clutter, or otherwise distract the user. As another example, a dev-ops team can be responsible for a particular service or tool and would like to limit output data received from the Pedoa system to the own service/tool (and potentially complementing processes of that service/tool). Consequently, the dev-ops team (e.g., a member thereof) can customize the Pedoa system using a customization configuration, such that service/tool data for the designated service/tool is only provided. In this manner, the Pedoa system does not clutter, or otherwise distract the dev-ops team.

In some implementations, the Pedoa system can be described as a user-data-based reporting system for landscapes and procedure status, which can access and leverage a landscape description, planned IT procedures, runtime data on executed IT procedures, and user personalization data. Further, and as described herein, the Pedoa system can report on one or more of:
planned processes for a defined period in time for entities (components) in the landscape and processes with metadata matching the user personalization data;
combining with statistics and deviation services report on success rate and runtimes of earlier runs of processes;
executed processes for a defined period of time for entities in the landscape and processes with metadata matching the user personalization data including the process success or error status, and runtime statistics; and
deviating processes for a defined period of time for entities in the landscape and processes with metadata matching the user personalization data, where runtime statistics data differs from average by more than a threshold (e.g., one or more standard deviations).

Further, and as described herein, the Pedoa system can derive selection criteria for reporting based on one or more of:
A user identifier (that uniquely identifies the user among other users) and user personalization data (e.g., customization configuration),
current date and time deriving planned and recent activities for a defined period of time (e.g., day, hour),
metadata of entities of the landscape, and
metadata of a process.

In some implementations, the Pedoa system has access to dependencies between components and/or processes. For example, the Pedoa system can access landscape information (e.g., from a landscape directory). For example, the Pedoa system can transmit a request to and receive information from a landscape directory provided in a landscape. Example landscape information can include, without limitation, information on the landscape of running services and systems, information on the dependency of services and systems (e.g., System_A calls system_B, System_C is called by System_B, Application_Q runs on System_A), information on usage statistics (e.g., Service_Q is called X times per second). In some examples, the Pedoa system has access to process information for processes (IT procedures) executed within the landscape. For a process, example process information can include, without limitation, the component (e.g., service, system) the process acts on, actions performed (e.g., start, stop, scale-out/-in, update version with downtime, update version w/o downtime), and a predecessor process and or a successor process of the process, if any. In some examples, the Pedoa system can provide information indicating that, if a particular process (e.g., Process_X) is executed for a particular system (e.g., System Y), the system will go down, if the system goes down, which other systems be impacted, if any, and/or, if the process fails, which other processes will be delayed.

In some implementations, and as described herein, the Pedoa system can convey information representative of process runtime statistics (e.g., duration, downtime, errors, resource consumption of the process), and services and system monitoring data during process execution time. In some implementations, the Pedoa system can provide information for particular processes (e.g., average runtime, standard deviation of runtime, etc.). In some examples, the Pedoa system can convey information for a particular process (e.g., Process_X) and a particular execution (run) of the process (e.g., R_x). Example information can include, without limitation, if the execution is within an average execution plus/minus one or more standard deviations, how much the execution deviates from the average execution, and how much the execution deviates from an average for a subset of the data defined by parameters (e.g., system type, data volume, time of day, etc.).

In accordance with implementations of the present disclosure, users can be supported by the Pedoa system in multiple use cases. As an example use case, the user can ask the Pedoa system, which actions are planned for the day or next day(s) within the domain (e.g., set of systems, set of components) that the user has configured (e.g., in a customization configuration). In response, the Pedoa system can query the respective services in the set of services 204 through the dispatcher 214 and return output data to the user. As another example, the user can ask Pedoa system about the statistics of the actions of the domain for the past day or previous day(s). In response, the Pedoa system can query the respective services in the set of services 204 through the dispatcher 214 and return output data to the user.

As another example, the user can initiate start of a task for a process within a domain. In response, the Pedoa system automatically (without the user requesting) monitors the task and provides output data representative of execution of the task (e.g., if the task failed, when the task is complete). In this manner, the user can attend to other things without actively monitoring the task. In some examples, the Pedoa system can inform the user as to whether the execution was average or an outlier, enabling the user to identify abnormal processes and potential bugs.

As another example, prior to initiating a task, the user can ask the Pedoa system for an impact assessment, which gauges an impact of execution of the task one the landscape (e.g., risk level in terms of failure potential and/or potential downtime). In this manner, the user can trigger execution of the task with higher confidence that the task will not result in the unexpected. As still another example, for a task, the user can ask Pedoa to provide analytics associated with the task (e.g., based on historical execution of the task) and drill-down options for data analysis related to the task (e.g. earlier runs runtime, resource consumption, follow-up problems . . . ). In this manner, the user can plan runtime and execute the task with higher confidence knowing how the task previously behaved in earlier runs.

As another example, if an error occurs, the user can ask the Pedoa system to provide environmental analysis, such as a deviation analysis. For example, the Pedoa system can provide analysis data indicating whether some parameter or setting of this system instance or process is run differing from the average. In this manner, the Pedoa system supports the user in efficiently finding and fixing the root cause. In some examples, the Pedoa system can provide an entry page for troubleshooting. In some examples, if an error occurs, the Pedoa system can automatically trigger a root cause analysis, or the user can trigger a root cause analysis through the Pedoa system to get recommendations (e.g., “create an incident on this component,” “call this support line,” “view this documentation,” “analyze the following data,” “run this command”).

As another example, the Pedoa system supports the user in housekeeping. For example, the user can ask the Pedoa system for recommended actions for a certain system, service, and/or process. In some examples, the Pedoa system alerts the user to tasks that should be executed and when each should be executed to maintain the system, service, and/or processes. In this manner, the user is alleviated from planning all housekeeping activities.

As another example, the Pedoa system can provide terminology related to landscape components managed by the user. For example, if the user has a question regarding a term occurring in their work, the Pedoa system can explain the term to the user. In some examples, the Pedoa system searches the term in a dictionary and/or wiki that is specific to the landscape, and returns a definition for and/or summary of the term in response to the user's query. As another example, the Pedoa can have access to documentation (e.g., image files, text files) that is relevant to the landscape, and can provide at least a portion of the documentation in response to a query from the user.

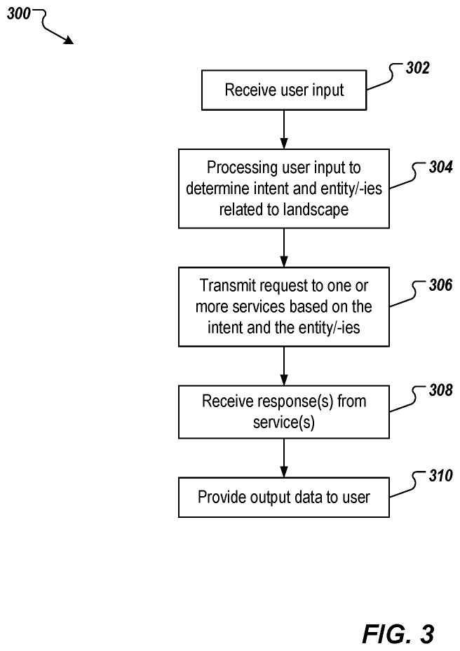

FIG. 3 depicts an example process 300 that can be executed in accordance with implementations of the present disclosure. In some examples, the example process 300 is provided using one or more computer-executable programs executed by one or more computing devices.

User input is received (302). For example, and as described herein, a Pedoa system for users of a landscape management system receives user input through one or more UIs. User input is processed to determine an intent and one or more entities (304). For example, and as described herein, the Pedoa system processes the user input to determine the intent and the one or more entities, which are each related to at least a portion of a landscape. A request is transmitted to one or more services (306). For example, and as described herein, a dispatcher of the Pedoa system transmits the request to one or more services of the Pedoa system based on the intent and the one or more entities. One or more responses are received (308). For example, and as described herein, the dispatcher of the Pedoa system receives one or more responses from the one or more services of the Pedoa system, each response being responsive to the request. Output data is provided to the user. For example, and as described herein, the Pedoa system provides output data to the user through one or more UIs, the output data being representative of activity of one or more components within the landscape.

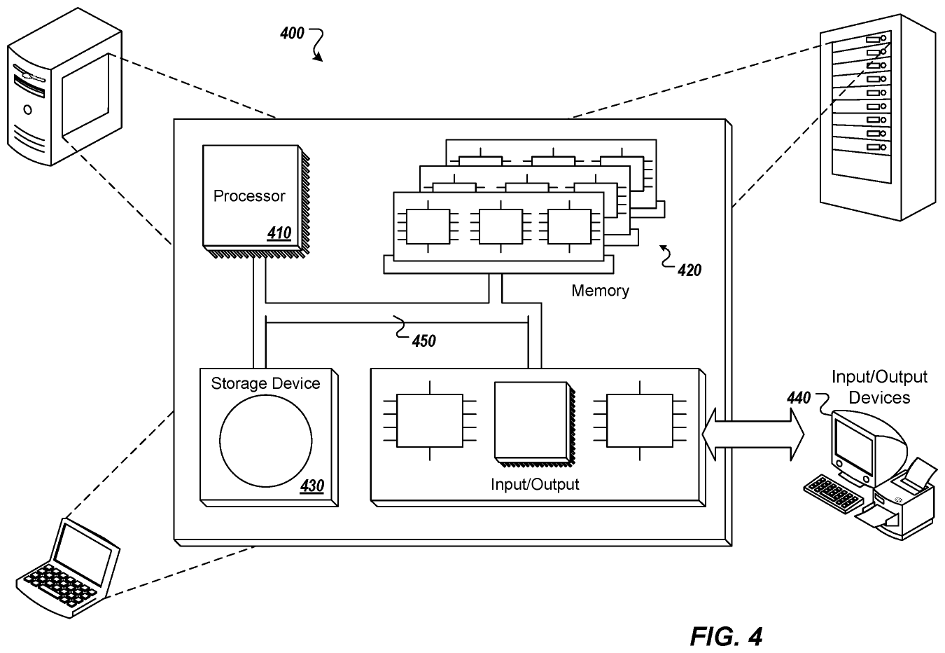

Referring now to FIG. 4, a schematic diagram of an example computing system 400 is provided. The system 400 can be used for the operations described in association with the implementations described herein. For example, the system 400 may be included in any or all of the server components discussed herein. The system 400 includes a processor 410, a memory 420, a storage device 430, and an input/output device 440. The components 410, 420, 430, 440 are interconnected using a system bus 450. The processor 410 is capable of processing instructions for execution within the system 400. In some implementations, the processor 410 is a single-threaded processor. In some implementations, the processor 410 is a multi-threaded processor. The processor 410 is capable of processing instructions stored in the memory 420 or on the storage device 430 to display graphical information for a user interface on the input/output device 440.

The memory 420 stores information within the system 400. In some implementations, the memory 420 is a computer-readable medium. In some implementations, the memory 420 is a volatile memory unit. In some implementations, the memory 420 is a non-volatile memory unit. The storage device 430 is capable of providing mass storage for the system 400. In some implementations, the storage device 430 is a computer-readable medium. In some implementations, the storage device 430 may be a floppy disk device, a hard disk device, an optical disk device, or a tape device. The input/output device 440 provides input/output operations for the system 400. In some implementations, the input/output device 440 includes a keyboard and/or pointing device. In some implementations, the input/output device 440 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for a personal digital operation assistant in landscape management, the method being executed by one or more processors and comprising:
receiving, by a personal digital operation assistant (Pedoa) system, user input;
processing, by the Pedoa system, the user input to determine an intent and one or more entities related to at least a portion of a landscape;
transmitting, by a dispatcher of the Pedoa system, a request to one or more services of the Pedoa system based on the intent and the one or more entities;
receiving, by the dispatcher, one or more responses from the one or more services of the Pedoa system, each response being responsive to the request; and
providing, by the Pedoa system, output data to a user through one or more user interfaces (UIs), the output data representative of activity of one or more components within the landscape.

2. The method of claim 1, wherein the one or more services of the Pedoa system comprise a schedule information service, a landscape information service, a tool information service, and a monitoring service.

3. The method of claim 1, wherein the output data is provided at least partially based on a customization configuration that defines one or more components of the landscape relevant to the user.

4. The method of claim 1, wherein the output data comprises statistics data representative of execution of a process within the landscape.

5. The method of claim 1, wherein the output data is audio data generated by a natural language processing (NLP) system at least partially based on the one or more responses.

6. The method of claim 1, wherein the one or more UIs comprise a graphical UI and a conversation UI (CUI), the CUI enabling speech-based communication between the Pedoa system and the user.

7. The method of claim 1, wherein the Pedoa system is integrated within a landscape management system that is used to manage the landscape.

8. A non-transitory computer-readable storage medium coupled to one or more processors and having instructions stored thereon which, when executed by the one or more processors, cause the one or more processors to perform operations for a personal digital operation assistant in landscape management, the operations comprising:
receiving, by a personal digital operation assistant (Pedoa) system, user input;
processing, by the Pedoa system, the user input to determine an intent and one or more entities related to at least a portion of a landscape;
transmitting, by a dispatcher of the Pedoa system, a request to one or more services of the Pedoa system based on the intent and the one or more entities;
receiving, by the dispatcher, one or more responses from the one or more services of the Pedoa system, each response being responsive to the request; and
providing, by the Pedoa system, output data to a user through one or more user interfaces (UIs), the output data representative of activity of one or more components within the landscape.

9. The computer-readable storage medium of claim 8, wherein the one or more services of the Pedoa system comprise a schedule information service, a landscape information service, a tool information service, and a monitoring service.

10. The computer-readable storage medium of claim 8, wherein the output data is provided at least partially based on a customization configuration that defines one or more components of the landscape relevant to the user.

11. The computer-readable storage medium of claim 8, wherein the output data comprises statistics data representative of execution of a process within the landscape.

12. The computer-readable storage medium of claim 8, wherein the output data is audio data generated by a natural language processing (NLP) system at least partially based on the one or more responses.

13. The computer-readable storage medium of claim 8, wherein the one or more UIs comprise a graphical UI and a conversation UI (CUI), the CUI enabling speech-based communication between the Pedoa system and the user.

14. The computer-readable storage medium of claim 8, wherein the Pedoa system is integrated within a landscape management system that is used to manage the landscape.

15. A system, comprising:
a computing device; and
a computer-readable storage device coupled to the computing device and having instructions stored thereon which, when executed by the computing device, cause the computing device to perform operations for anomaly detection for a personal digital operation assistant in landscape management, the operations comprising:
receiving, by a personal digital operation assistant (Pedoa) system, user input;
processing, by the Pedoa system, the user input to determine an intent and one or more entities related to at least a portion of a landscape;
transmitting, by a dispatcher of the Pedoa system, a request to one or more services of the Pedoa system based on the intent and the one or more entities;
receiving, by the dispatcher, one or more responses from the one or more services of the Pedoa system, each response being responsive to the request; and
providing, by the Pedoa system, output data to a user through one or more user interfaces (UIs), the output data representative of activity of one or more components within the landscape.

16. The system of claim 15, wherein the one or more services of the Pedoa system comprise a schedule information service, a landscape information service, a tool information service, and a monitoring service.

17. The system of claim 15, wherein the output data is provided at least partially based on a customization configuration that defines one or more components of the landscape relevant to the user.

18. The system of claim 15, wherein the output data comprises statistics data representative of execution of a process within the landscape.

19. The system of claim 15, wherein the output data is audio data generated by a natural language processing (NLP) system at least partially based on the one or more responses.

20. The system of claim 15, wherein the one or more UIs comprise a graphical UI and a conversation UI (CUI), the CUI enabling speech-based communication between the Pedoa system and the user.
